(19) United States
(12) Patent Application Publication
(10) Pub. No.: US 2005/0038640 A1
(43) Pub. Date: Feb. 17, 2005

(54) Method and apparatus for automatically testing the design of a simulated integrated circuit

(75) Inventor: Baker David, Cambridge (GB)

Correspondence Address: JONES DAY, 222 EAST 41ST ST, NEW YORK, NY, 10017, US

(73) Assignee: Virata Limited

(21) Appl. No.: 10/773,113

(22) Filed: Feb. 4, 2004

Related U.S. Application Data
(63) Continuation of application No. 09/529,126, filed on Aug. 28, 2000, now abandoned.

(30) Foreign Application Priority Data
Nov. 25, 1997 (GB) GB 9724895.9

(51) Int. Cl. G06F 17/50

(52) U.S. Cl. 703/16

(57) ABSTRACT

A method and apparatus for automatically testing the design of a simulated integrated circuit containing a network of flip-flops. The network is put into a reset state and each flip-flop is tested to determine if it has expected input and output states. If the flip-flop is likely to transition, it is listed as a potential fault.

This invention relates to a method of automatically testing the design of a simulated integrated circuit containing a plurality of flip-flops. The method can be used by an ASIC designer to verify the correct operation of a circuit under initial reset conditions.

In the design of integrated circuits, sequential levels of the complexity in the design are simulated by an ASIC designer. For example, one level of design simulation may contain diagrammatic representations of flip-flops. In another different level, these flip-flops would be represented by individual gates and in a further level, by the semiconductor architecture of the integrated circuit. If any of these flip-flops would not operate correctly in the final design, this would affect the integrity of the integrated circuit. As modern ASIC designs generally contain a large amount of flip-flops which are controlled by global clock and reset networks, the timing relationship between the clock and the reset at each flip-flop is important. Otherwise the flip-flop may enter a metastable state when the reset is released, and this would cause different subsystems within the ASIC to lose synchronisation, thereby leading to system failure.

In the prior art, there are two common solutions to this problem. These globally modify the circuit and they can be applied automatically without an in-depth understanding of the circuit. However, they can add up to 5% overhead to the silicon area and are thus not cost-effective.

One prior art solution is concerned with synchronous reset flip-flops, for example, where all flip-flops are replaced with a type that synchronises the reset to the clock input. This technique has the disadvantages that the type of flip-flop required is larger and slower than the normal type; the cost of silicon is increased; and performance is reduced. The other prior art solution employs a reset tree, and this requires extra circuitry to balance the reset network. The base of this network is synchronised with the clock, so that the designer can control the timing of the reset signal and thereby avoid the problem. The disadvantage is that adding the reset tree increases the silicon area and this leads to higher cost.

The present invention seeks to avoid the extra cost of the above methods by enabling the designer to pinpoint flip-flops which suffer from a reset problem. The designer will then be able to modify the circuit to solve the problem locally.

U.S. Pat. No. 5,650,946 shows how to simulate the behaviour of a circuit using an event-driven approach. It describes various approaches to simulation but does not disclose any means for correcting defective circuit behaviour. WO-A-94/23388 discloses a technique for identifying the occurrence of asynchronous behaviour in a simulation and correcting the simulation so that it operates properly. WO-A-94/02906 describes a technique for accurately modelling a device which exhibits asynchronous behaviour so that the simulation will operate correctly. Thus, the aim of all of these prior art techniques is to model a circuit so that the simulation operates correctly, i.e. with correct asynchronous operation, whereby the dynamic nature of the problem is addressed. In contrast, the invention simulates a circuit with reset flip-flops, identifies (by static analysis) which of these have potentially metastable defects, and then modifies the circuit design either by changing the reset state of the flip-flop, or by the local application of logic (such as AND-gates), so that the circuit functions correctly.

According to the invention, a method of automatically testing the design of a simulated integrated circuit (ASIC) includes the steps of:
simulating an integrated circuit having a level containing a network of flip-flops;
putting the network into a reset state in which each flip-flop would have an expected input and output state, scanning the network and listing the input and output states;
listing the flip-flops with other than the expected input and output states as having potential faults;
examining each potential fault; and
modifying the circuit design to change the reset state of the flip-flop, or to add logic to remedy the fault.

The reset state of the flip-flop can be changed by amending the HDL source code for the ASIC. If logic needs to be added instead, this could add an enable signal for one or more (e.g. a group) of flip-flops. When the network of flip-flops is put into a reset state, all set D-type flip-flops will have their outputs-high and all reset D-types will have their outputs low. The netlist is then scanned to check that all set type flip-flops have the D input high and all reset type flip-flops have the D input low. This will indicate whether the flip-flops would transition on the next clock if the reset was removed.

The invention makes use of the fact that a flip-flop in a stable internal state will not go metastable when reset is released. This stable state is defined as the state in which the output value will not change on the next active clock transition. For a D type flip-flop, this state occurs when the D input matches the Q output, i.e. the logic level is the same, or the voltages are those which are expected. The state of the D input is only important at the transition time of the clock. At other times it can be ignored. However when the network is held in reset all the internal signals will become stable so that the static D input can be treated as the next output. It is not necessary for the D input to be precisely equal to the Q output for a match to occur. For example, the output of a D flip-flop is constant (i.e. is remains in its previous state) until its C input is clocked. When its C input is clocked, its Q output equals its D input until the next clock pulse transition. A set D type flip-flop requires the D input to be high and conversely a reset D type requires the input to be low. Thus, the output can be forced high or low by either a set or reset input, depending on the type.

Whilst a single clock pulse edge could cause a faulty flip-flop to transition, it may be necessary to apply a series (e.g. a finite number) of clock pulses to ensure that any flip-flops with no specific reset state have settled into a static pattern.

In the preferred embodiment of the invention, a net list is analysed before reset on the network is released.

For a T type flip-flop the stable condition would be the T input inactive. For a J-K flip-flops the stable condition is J=1 K=0 when output is set and J=0 K=1 when output is clear.

Similar conditions can be defined for any particular flip-flop type.

A list of potential faults is presented to the designer, who can then address each fault by either changing the reset state, or in some circumstances adding extra logic. This extra logic will be small in cost compared to globally added circuitry which is used in the prior art methods described above. The aim of the designer is to have a single flip-flop that comes out of reset first and then enables the rest of the circuit. Such a structure will exit reset in a safe manner.

A preferred embodiment of the invention will now be described with reference to the accompanying drawing in which:

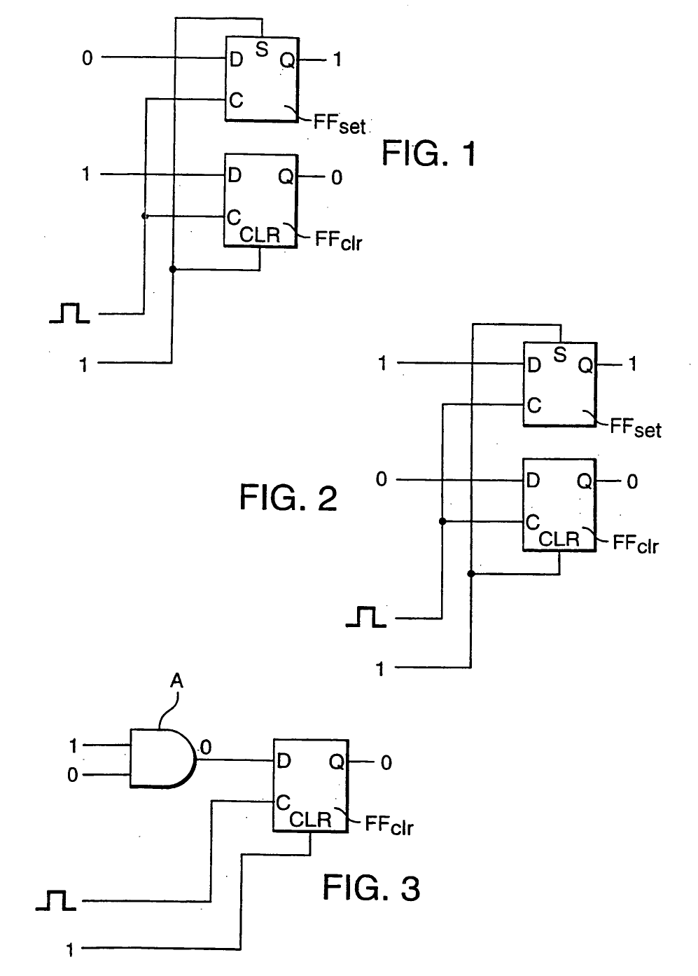

FIG. 1 represents an unstable D flip-flop network in a level of integrated circuit simulation;

FIG. 2 represents a stable D flip-flop network; and

FIG. 3 represents a D flip-flop in which the potential fault has been fixed by using logic.

Referring to the drawings, each simulated D type flip-flop FFₛₑₜ, FF_{clr}, has a D input, a Q output and a clock C input connected to a source of clock pulses. The flip-flops FFₛₑₜ are of the set type where logic 1 on the D input produces logic 1 on the Q output. The flip-flops FF_{clr} are of the clear type where logic 1 on the D input produces logic 0 on the Q output. The network of flip-flops is put into a reset state in which each flip-flop would have an expected input and output state. The network is then scanned and the input and output states are listed. FIG. 1 illustrates an unstable flip-flop network where the D input (0) does not match the Q output (1) and the flip-flop would transition on a subsequent clock pulse edge. This flip-flop network is listed or flagged as a potential fault. However, in FIG. 2, the flip-flop network is stable and there is no potential fault.

It can be seen, by analogy, that the clear flip-flops in the networks of FIGS. 1 and 2 are respectively unstable and stable.

In order to fix the fault, an AND-gate A can be used, as shown in FIG. 3. This normally applies logic 1 and 0 to the inputs of the AND-gate, as shown, whereby the Q output is 0 when the D input is 0 (which is the output of the AND-gate). An enabling pulse (logic 1) can then be applied, at an appropriate time, so that both inputs of the AND-gate are at logic 1 to ensure that the Q output will be at logic 1.

In the preferred technique, a PLI routine is linked with a Cadence Verilog Simulator. PLI stands for “Programming Language Interface” and is an industry standard method of interfacing with the internal state of a compliant simulator. The interface involves writing a C program that calls a defined set of interface functions. The source code for the PLI functions is not included in this disclosure since the principles involved will be understood by those skilled in the art. The technique involves splitting the system up into two parts, the first logs the internal netlist state to a file and the second examines the file to produce a log report. This is done only for convenience because it is possible (in theory) to do all the processing in a single stage.

It is also possible to develop a stand alone program that could apply the entire method. The Verilog/PLI route was used for developing a working prototype.

The Cadence Verilog Simulator is known to ASIC designers. The following text is printed when it starts.
<VERILOG-XL 2.5.13 Nov. 17, 1997 14:43:58
<
<Copyright (c) 1995 Cadence Design Systems.Inc. All Rights Reserved.
<Unpublished—rights reserved under the copyright laws of the United States
<
<Copyright (c) 1995 UNIX Systems Laboratories.Inc. Reproduced with Permission.

A Verilog control program is then used to force a test netlist into a reset state and then to call a PLI code that logs the state of the inputs and outputs of each flip-flop. This logged information is post-processed by an off-line program to create a list of flip-flops that have potential faults and that could enter a metastable state after reset.

1. A method of automatically and statically testing the design of a simulated integrated circuit (ASIC) includes the steps of:
simulating a circuit having a level containing a network of flip-flops;
putting the network in a reset state, in which each flip-flop would have an expected input and output state,
scanning the network and listing the input and output states;
listing the flip-flops with other than the expected input and output states as having potential faults;
examining each potential fault; and
modifying the circuit design so as to change the reset state of the flip-flop, or to add logic (a) to remedy the fault, so that when the modified design is retested by putting the network into a reset state and by releasing the reset state, each flip-flop will not go metastable when the reset state is released, a stable state being achieved in said flip-flop when its output value does not change on a subsequent active clock transition.

2. A method according to claim 1 wherein the flip-flops are of the D type.

3. A method according to claim 1 wherein the flip-flops are of the T type.

4. A method according to claim 1 wherein the flip-flops are of the J-K type.

5. A method according to any preceding claim wherein a PLI routine is linked with a simulator and a control program is then used to force a test netlist into a reset state; a PLI code being called to log the state of the inputs and outputs of each flip-flop and the logged information being post-processed to create a list of flip-flops that have potential faults.

6. Apparatus for automatically and statically testing the design of a simulated integrated circuit, the apparatus including:
means for simulating an integrated circuit having a network of flip-flops;
means for scanning the network and for listing the input and output states;
means for listing the flip-flops which have potential faults;
means for examining each potential fault; and
means for modifying the circuit design to change the reset state of the flip-flop, or to add logic (A) to remedy the fault, so that when the modified design is retested by putting the network into a reset state and by releasing the reset state, each flip-flop will not go metastable when the reset state is released, a stable state being achieved in said flip-flop when its output value does not change on a subsequent active clock transition.

7. Apparatus according to claim 6 wherein a PLI routine is linked with a simulator and a control program is then used to force a test netlist into a reset state, a PLI code being called to log the state of the inputs and outputs of each flip-flop and the logged information being post-processed to create a list of flip-flops that have potential faults.
